(19) United States
(12) Patent Application Publication
(10) Pub. No.: US 2024/0428020 A1
(43) Pub. Date: Dec. 26, 2024

(54) REVERSIBLE SPEECH-TO-SPEECH TRANSLATION FOR CONVERSATIONAL AI SYSTEMS AND APPLICATIONS

(71) Applicant: NVIDIA Corporation, Santa Clara, CA (US)

(72) Inventors: Xianchao Wu, Tokyo (JP); Simon SEE Chong Wee, West Coast Rise (SG)

(21) Appl. No.: 18/212,408

(22) Filed: Jun. 21, 2023

(51) Int. Cl. G06F 40/58; G10L 15/06; G10L 15/16; G10L 25/18

(52) U.S. Cl. CPC G06F 40/58; G10L 15/063; G10L 15/16; G10L 25/18; G10L 15/30

(57) ABSTRACT

Disclosed are apparatuses, systems, and techniques that may use machine learning for reversible translations of speech utterances. The techniques include training and using duplex neural networks (NNs) having a first subnetwork and a second subnetwork that are mirror images of each other. Training data for training the duplex NNs may include a target output that includes a first speech utterance in a first language, a first training input that includes the target output distorted by a noise, and a second training input that includes a second speech utterance in a second language. The duplex NNs may be trained to identify, using the first training input and the second training input, at least one of the target output or the first noise.

### TECHNICAL FIELD

At least one embodiment pertains to processing resources used to perform and facilitate speech translation. For example, at least one embodiment pertains to neural networks that are capable of translating speech from a first language to a second language and translating speech from the second language to the first language.

### BACKGROUND

Machine translation of texts from one language to another language is often performed using rule-based techniques (e.g., by deploying a large number of linguistic rules), statistical techniques (e.g., by using statistics of word/phrase usage in the two languages), or neural networks. Neural networks typically encode input texts in the first language via machine embeddings and subsequently decode the machine embeddings to obtain output texts in the second language. Neural networks-based translation techniques have achieved significant progress in text-to-text (T2T) translations over the last decade. Speech-to-speech (S2S) translation involves receiving an input spoken utterance and converting the received utterance into an output utterance in a different language. S2S translation can be performed in multiple stages, e.g., by first converting the received utterance into a text using automated speech recognition (ASR), performing T2T machine translation of the text to the second language, and then converting text in the second language to the output spoken utterance in the second language using one of text-to-speech (T2S) synthesis models.

### BRIEF DESCRIPTION OF DRAWINGS

FIG. 1 is a block diagram of an example computer system capable of implementing accurate and efficient duplex (bidirectional) speech-to-speech translation of utterances between different languages in a reversible manner and in real time, according to at least one embodiment;

FIG. 2 illustrates an example computing device which may train or deploy models for efficient and accurate duplex speech-to-speech translations, according to at least one embodiment;

FIG. 3 illustrates schematically an example architecture of a duplex model capable of reversible translations of speech utterances between different languages, according to at least one embodiment;

FIG. 4 illustrates evolution of a noise training utterance over N noise sampling epochs, for training of a duplex model capable of reversible speech-to-speech translations, according to at least one embodiment;

FIG. 5 is a flow diagram of an example method of using a duplex model capable of reversible translations of speech utterances, according to at least one embodiment;

FIG. 6 is a flow diagram of an example method of training a duplex model capable of reversible translations of speech utterances, according to at least one embodiment;

### DETAILED DESCRIPTION

Existing S2S neural network models include Translatotrons that deploy a speech encoder and a spectrogram decoder. The speech encoder encodes speech via embeddings (feature vectors) while the spectrogram decoder decodes the embeddings to obtain spectral representations, e.g., mel-spectrograms, of the output speech. Existing S2S neural network models also include speech-to-unit translators that use discrete clustered units in the target language instead of spectrograms. Existing techniques further include multi-pass systems, e.g., four-module UnitY system that includes a speech encoder, a first-pass text decoder, a text-to-unit encoder, and a second-pass unit decoder. While achieving considerable success in simplex (unidirectional) translations from a source language to a target language, these techniques are less effective in duplex translations where speech has to be translated in both directions, as happens, e.g., during live dialogue where participants speak two different languages. The existing techniques address such situations by deploying two separate models, each model trained for a particular simplex translation, or by training a unified model capable of translating speeches between two languages in both directions using multi-task learning techniques. Such multi-task trained models, however, demonstrate suboptimal performance and low efficiency.

Aspects and embodiments of the present disclosure address these and other challenges of the modern language processing technology by providing for techniques and systems that enable accurate and efficient duplex (bidirectional) S2S translations. The disclosed duplex model is reversible in the sense that a speech utterance, x, spoken in one language may be translated into a corresponding utterance in the second language, x→y, which utterance may then be translated back to the first language, y→\tilde{x}, to obtain utterance \tilde{x} that is identical to the initial utterance (\tilde{x}=x) or substantially the same as the initial utterance (\tilde{x}≈x). Similarly, the reversibility of translation may further be enabled in the other direction, y→x→\tilde{y}≈y, to realize a full cycle consistency. One end of the duplex model can receive input utterances and provide output utterances in the first language and the other end of the duplex model may, correspondingly, provide output utterances and receive input utterances in the second language. The reversibility of the duplex model may be achieved by a mirrored structure of an underlying neural network architecture. For example, the duplex model may include N blocks of neural layers L₁, L₂, . . . , L_{2N} such that the first half of the blocks, L₁, . . . , L_{N}, mirrors the second half, L_{N+1}, . . . , L_{2N}. In particular, block Lⱼ may be a mirror image of block L_{2N-j+1}. In some embodiments, at least some of the blocks of the model may be conformer blocks, e.g., may include a combination of self-attention module(s), convolutional module(s), and feed-forward module(s). For example, a pair of feed-forward layers may sandwich a self-attention layer and a convolutional layer. Blocks may include residual connections, split inputs, and/or other features. The self-attention layer(s) may include multiple heads. Convolutional layers may include pointwise and/or depthwise convolutions. In the disclosed architecture, attention layers capture a global context of an utterance being translated while convolutions explore local features of various parts of the utterance.

During training, the duplex translation model may be trained to generate an (unknown to the model) target utterance x in the first language corresponding to a given training utterance y in the second language. Similarly, training may include a reverse process of generating a target utterance y′ in the second language corresponding to a training utterance x′ in the first language. To achieve higher efficiency and stability, training of the duplex translation model may include diffusion model training techniques. More specifically, a target utterance x₀ may be distorted with a randomly sampled noise ϵₓ into a noisy utterance xₙ, where n may be a randomly selected level of noise from a set of predetermined noise levels. The model may then be trained to recover, from the distorted xₙ and the corresponding (undistorted) utterance y₀ in the second language, the undistorted target utterance x₀ (or, equivalently, the noise ϵₓ used to distort the target utterance). In some embodiments, the distorted xₙ may be treated as the subject of attention key-value pairs in self-attention layers of the model with the utterance y₀ being treated as the query. In some embodiments, the noise ϵₓ may be predicted directly from the distorted xₙ with the training utterance y₀ being treated as the conditional variable. Similarly, during a reverse pass, training may include recovering, from a noise-distorted yₙ and the corresponding (undistorted) utterance x₀ in the first language, the undistorted target utterance y₀ in the second language (or, equivalently, the noise ϵ_{y} used to distort the target utterance). Forward and reverse training passes may be alternated, so that the duplex model learns the full cycle consistency of reversible translations.

The advantages of the disclosed techniques include but are not limited to training and deployment of models capable of accurate reversible of speech-to-speech translations between different languages. Such reversible speech-to-speech translator models allow for, among other things, real-time dialogues between people speaking different languages as well as translation of speech to/from languages that do not have a writing system.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems for generating or presenting at least one of augmented reality content, virtual reality content, mixed reality content, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implementing one or more language models, such as large language models (LLMs) (which may process text, voice, image, and/or other data types to generate outputs in one or more formats), systems implemented at least partially using cloud computing resources, and/or other types of systems.

### System Architecture

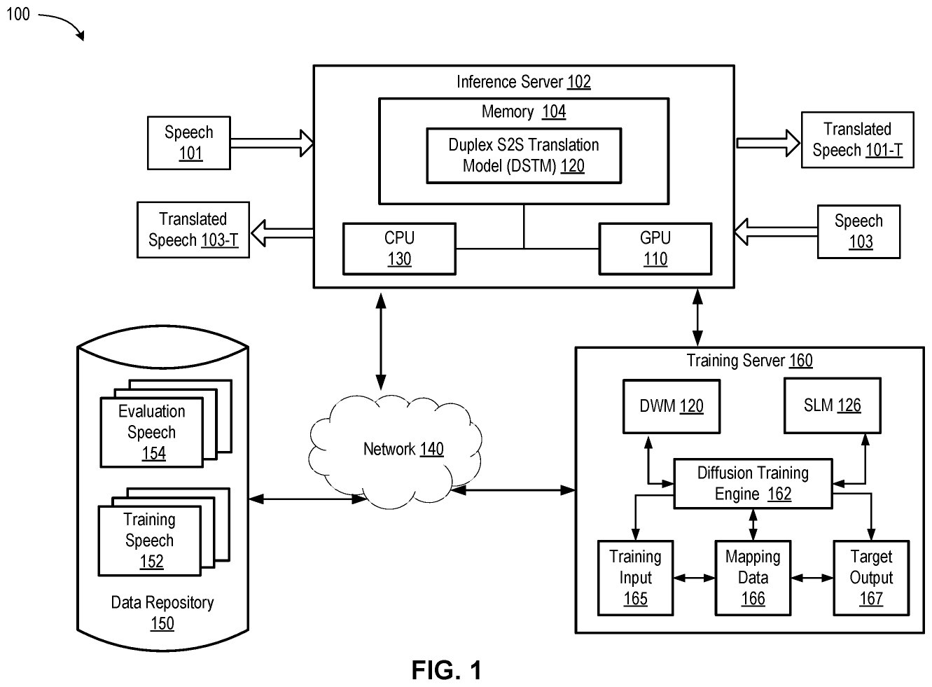

FIG. 1 is a block diagram of an example computer system 100 capable of implementing accurate and efficient duplex (bidirectional) speech-to-speech translation of utterances between different languages in a reversible manner and in real time or near real time, according to at least one embodiment. As depicted in FIG. 1, a computer system 100 may include an inference server 102, a data repository 150, and a training server 160 connected to a network 140. Network 140 may be a public network (e.g., the Internet), a private network (e.g., a local area network (LAN), or wide area network (WAN)), a wireless network, a personal area network (PAN), a combination thereof, and/or another network type.

Inference server 102 may include a desktop computer, a laptop computer, a smartphone, a tablet computer, a server, a wearable device, a virtual reality/augmented reality/mixed headset or heads-up display, a digital avatar or chatbot kiosk, an in-vehicle infotainment computing device, and/or any suitable computing device capable of performing the techniques described herein. Inference server 102 may be configured to receive speech 101 that may be associated with any speech episode involving multiple speakers. Speech episodes may include a public or private conversation, a business meeting, a public or a private presentation, an artistic event, a debate, an interaction between a digital agent (e.g., chat bot, digital avatar, etc.) and a user(s), an in-vehicle communication (e.g., between two or more occupants, between an occupant(s) and a chat bot, avatar, or digital assistant of the vehicle), and/or the like. Speech 101 may be recorded using one or more devices connected to inference server 102, retrieved from memory 104 of inference server 102, and/or received over any local or network connection (e.g., via network 140) from an external computing device. Speech 101 may be in any suitable format, e.g., WAV, AIFF, MP3, AAC, WMA, or any other compressed or uncompressed format. In some embodiments, speech 101 may be stored (e.g., together with other data, such as metadata) in data repository 150. Speech 101 may be in a first language. Inference server 102 may process speech 101 and generate a translated speech 101-T that is translation of speech 101 to second language. The first language and/or the second language may be any language, which may have or have not a writing system. Inference server 102 may also process any speech 103 in the second language and generate a translated speech 103-T that is translation of speech 103 to the first language. Additionally, data repository 150 may store training speech 152 for training one or more models capable of reversible S2S translation and evaluation speech 154 for evaluation of the trained models, according to some embodiments disclosed herein. Data repository 150 may be accessed by inference server 102 directly or (as shown in FIG. 1) via network 140.

Data repository 150 may include a persistent storage capable of storing audio files as well as metadata for the stored audio files. Data repository 150 may be hosted by one or more storage devices, such as main memory, magnetic or optical storage disks, tapes, or hard drives, network-attached storage (NAS), storage area network (SAN), and so forth. Although depicted as separate from inference server 102, in at least some embodiments, data repository 150 may be a part of inference server 102. In at least some embodiments, data repository 150 may be a network-attached file server, while in other embodiments data repository 150 may be some other type of persistent storage such as an object-oriented database, a relational database, and so forth, that may be hosted by a server machine(s) or one or more different machines coupled to the inference server 102 via network 140.

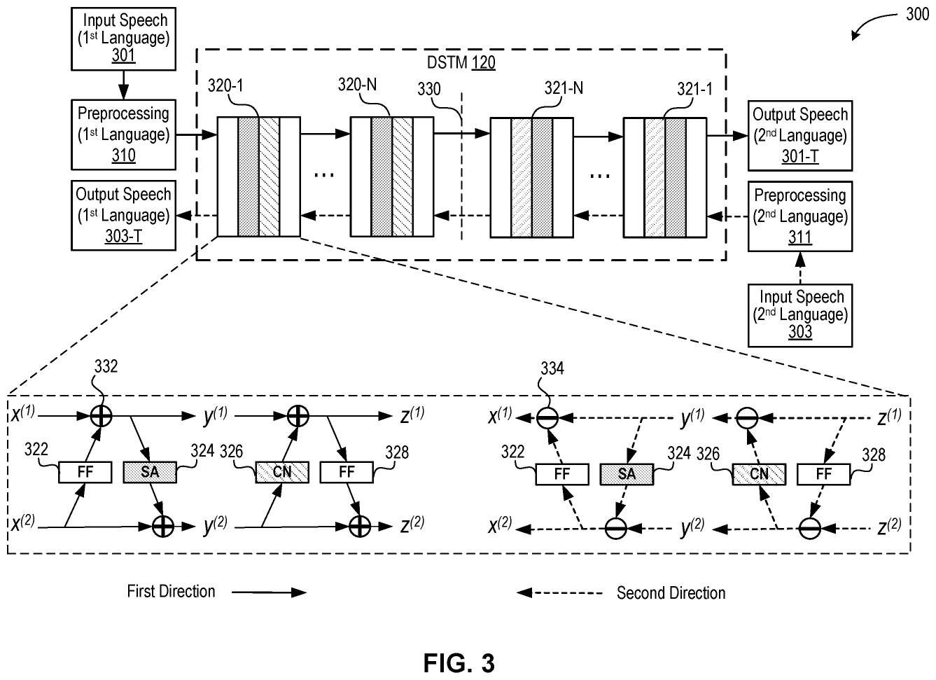

Inference server 102 may include a memory 104 (e.g., one or more memory devices or units) communicatively coupled with one or more processing devices, such as one or more graphics processing units (GPU) 110 and/or one or more central processing units (CPU) 130. In some embodiments, inference server 102 may deploy one or more data processing units (DPU), one or more parallel processing units (PPUs), one or more deep learning accelerators (DLAs), and/or other suitable processing devices, including but not limited to application-specific integrated circuits (ASIC), field-programmable gate arrays (FPGA), and/or the like. Memory 104 may include random access memory (RAM), read-only memory (ROM), high-speed cache, flash memory, and/or the like. Memory 104 may store one or more models operating according to implementations of the present disclosure, such as a speaker duplex S2S translation model (DSTM) trained to process speech 101 in the first language and speech 103 in the second language and output translated speech 101-T in the second language and translated speech 103-T in the first language. DSTM 120 may be executed by GPU 110, CPU 130, and/or any other processing device of inference server 102. In some embodiments, DSTM 120 may use speech 101 as an input, which may include training speech 152 or evaluation (inference) speech 154. DSTM 120, operating in a first direction, may translate speech 101 from the first language to the second language in a reversible way. In particular, if translated speech 101-T is used as speech 103 (in the second language) input into DSTM 120 operating in the second direction, the output of DSTM 120 (translated speech 103-T) may be the same (or substantially the same) as speech 101 (in the first language). Specifics of operations of DSTM 120 are disclosed below in conjunction with FIGS. 3-6.

Speech 101 and/or speech 103 (which may include training speech 152 and/or evaluation speech 154) may be stored in a data repository in a raw audio format, in the form of spectrograms, or in any other suitable digital representation. For example, a spectrogram of speech 101 may be obtained by recording air pressure caused by the speech as a function of time and computing a short-time Fourier transform for overlapping time intervals (frames) of a set duration. This maps the audio signal from the time domain to the frequency domain and generates a spectrogram characterizing the spectral content of speech 101. The amplitude of the audio signal may be represented on a logarithmic (decibel) scale. In some embodiments, the obtained spectrograms may be further converted into mel-spectrograms, by transforming frequency f into a non-linear mel domain, f→m=aln(1+f/b), to take into account the ability of a human ear to distinguish better equally spaced frequencies (tones) at the lower end of the frequencies of the audible spectrum than at its higher end; for example, a=1607 and b=700 Hz. Throughout this disclosure, the term “spectrogram” should be understood to include spectrograms, e.g., mel-spectrograms, where applicable.

In at least one embodiment, DSTM 120 may be implemented as a deep learning neural network having multiple levels of linear and non-linear operations. In at least one embodiment, DSTM 120 may include multiple neurons that receive inputs from other neurons and/or from an external source and may produce an output by applying an activation function to the sum of weighted inputs and a bias value. In at least one embodiment, DSTM 120 may include multiple neurons arranged in layers, including an input layer, one or more hidden layers, and/or an output layer. DSTM 120 may include convolutional neural layers, fully-connected neural networks, recurrent neural layers, neural networks with memory layers/subnetworks, transformers, conformers, and/or other neural networks. DSTM 120 may be trained by training server 160.

Training server 160 may use training speech 152 to identify parameters (e.g., neural weights, biases, parameters of activation functions, etc.) of DSTM 120 that maximize success of and accuracy of reversible S2S translations. Training server 160 may be hosted by a desktop computer, a laptop computer, a smartphone, a tablet computer, a server, and/or any suitable computing device capable of performing the techniques described herein. In at least one embodiment, training server 160 and inference server 102 may be implemented on a single computing device.

Training server 160 may deploy a diffusion training engine 162 that uses training inputs 165 to train DSTM 120 to perform reversible S2S translations that are stable against noise distortions. Diffusion training engine 162 may also generate mapping data 166 (e.g., metadata) that associates training inputs 165 with correct target outputs 167 (ground truth). During training of DSTM 120, diffusion training engine 162 may identify patterns in training input(s) 165 based on desired target output(s) 167 and identify parameters of DSTM 120 that maximize accuracy of S2S translations and resilience of S2S translations against addition of noise to training inputs 165 and/or target outputs 167.

In some implementations, diffusion training engine 162 may perform training of DSTM 120 in stages. In particular, during a first stage, diffusion training engine 162 may train DSTM 120 to perform two-way translations using noiseless training inputs 165 and target outputs 167. During a second stage, diffusion training engine 162 may use noisy training data. For example, diffusion training engine 162 may sample noise using a suitable distribution (e.g., the normal distribution) to distort target outputs 167 (in the first or second language) and train DSTM 120 to identify undistorted target outputs 167 starting form given (e.g., undistorted) training inputs 165. A similar process may then be performed in the reversed direction. Predictive utility of DSTM 120 may be subsequently verified using additional training input/target output associations. During the inference (evaluation) stage, trained DSTM 120 may use the identified patterns for processing of evaluation speech 154 not previously seen by DSTM 120.

During training, initial parameters (edge weights and biases) of DSTM 120 may be assigned some starting (e.g., random) values. For every training input 165, training engine 162 may cause DSTM 120 to generate training outputs. Training engine 162 may then compare observed training outputs to the target outputs 167. The resulting error or mismatch, e.g., the difference between the target outputs 167 and the actual output(s) of the neural networks, may be quantified using one or more suitable loss functions and back-propagated through neural networks of DSTM 120. Various parameters (e.g., weights and biases) of the neural network(s) may be adjusted to make the training outputs closer to the target outputs 167. This adjustment may be repeated until the output error for a given training input 165 satisfies a predetermined condition (e.g., falls below a predetermined value) or converges to an acceptable level of accuracy. Subsequently, a different training input 165 may be selected, a new output generated, and/or a new series of adjustments implemented, until the respective neural networks are trained to a target degree of accuracy. In some embodiments, training of DSTM 120 may be supervised (e.g., using human annotations of training speech 152 with speaker identities as ground truth), unsupervised, and/or semi-supervised.

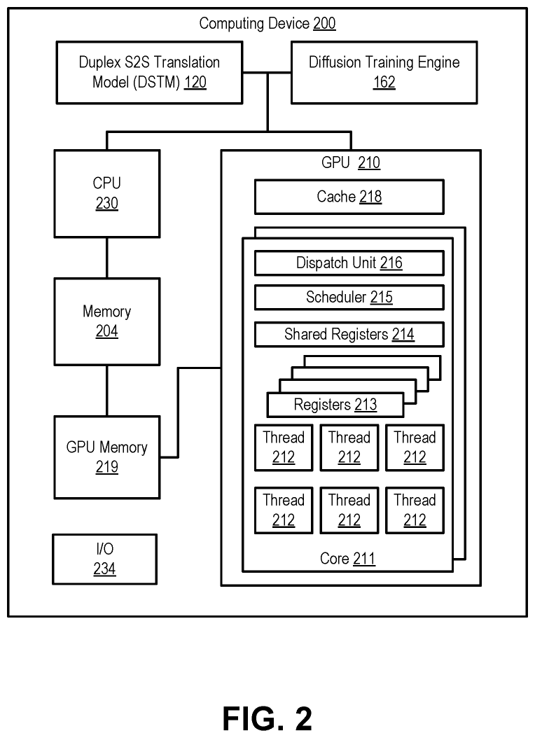

FIG. 2 illustrates an example computing device 200 which may train or deploy models for efficient and accurate duplex speech-to-speech translations, according to at least one embodiment. In at least one embodiment, computing device 200 may be a part of inference server 102. In at least one embodiment, computing device 200 may be a part of training server 160. In at least one embodiment, DSTM 120 and/or diffusion training engine 162 may be executed using one or more GPUs 210, CPUs 230, PPUs, DPUs, deep learning accelerators, and/or the like. In at least one embodiment, a GPU 210 includes multiple cores 211, some or all cores 211 being capable of executing multiple threads 212. Some or all cores 211 may run multiple threads 212 concurrently (e.g., in parallel). In at least one embodiment, threads 212 may have access to registers 213. Registers 213 may be thread-specific registers with access to a register restricted to a respective thread. Additionally, shared registers 214 may be accessed by one or more (e.g., all) threads of the core. In at least one embodiment, some or all cores 211 may include a scheduler 215 to distribute computational tasks and processes among different threads 212 of core 211. A dispatch unit 216 may implement scheduled tasks on appropriate threads using correct private registers 213 and shared registers 214. Computing device 200 may include input/output component(s) 234 to facilitate exchange of information with one or more users or developers.

In at least one embodiment, GPU 210 may have a (high-speed) cache 218, access to which may be shared by multiple cores 211. Furthermore, computing device 200 may include a GPU memory 219 where GPU 210 may store intermediate and/or final results (outputs) of various computations performed by GPU 210. After completion of a particular task, GPU 210 (or CPU 230) may move the output to (main) memory 204. In at least one embodiment, CPU 230 may execute processes that involve serial computational tasks whereas GPU 210 may execute tasks (such as multiplication of inputs of a neural node by weights and adding biases) that are amenable to parallel processing. In at least one embodiment, specific applications, e.g., DSTM 120 and/or diffusion training engine 162 may determine which processes are to be executed on GPU 210 and which processes are to be executed on CPU 230 (and/or other processing units). In other embodiments, CPU 230 may determine which processes are to be executed on GPU 210 and which processes are to be executed on CPU 230 (and/or other processing units).

### Duplex Models for Reversible Speech-to-Speech Multi-Language Translations

FIG. 3 illustrates schematically an example architecture 300 of a duplex model capable of reversible translations of speech utterances between different languages, according to at least one embodiment. In at least one embodiment, the duplex model of FIG. 3 may be implemented using training server 160 and/or inference server 102, which may be located on a single computing device or on two or more computing devices.

As illustrated in FIG. 3, input speech 301 may include one or more utterances in a first language. Input speech 301 may have a duration from one or several seconds to several minutes or even longer. Input speech 301 may be generated, e.g., spoken, by one or more speakers and may be associated with a single speech episode or multiple speech episodes. Input speech 301 may undergo speech preprocessing 310, which may include audio filtering, denoising, amplification, and/or any other suitable enhancement. Speech preprocessing 310 may further include removal of portions of input speech 301 that do not have a speech content. For example, speech preprocessing 310 may process acoustic energy e(t) of input speech 301 as a function of time and identify regions of input speech 301 that have energy less than a certain threshold (e.g., an empirically determined noise threshold). Such identified regions may be removed (trimmed) from input speech 301 during speech preprocessing 310.

In some embodiments, speech preprocessing 310 may include segmenting input speech 301 into intervals of a fixed size (scale, duration) τ, which may be non-overlapping or partially overlapping intervals. Segmented input speech 301 may undergo a suitable speech-to-spectrogram transformation. For example, spectrograms of input speech 301 may be obtained by performing a discrete Fourier transform of acoustic energy e(t) (or air pressure p(t)) for individual intervals of input speech 301. The obtained spectrograms e(fⱼ) may be defined for a number of bands f₁, f₂ . . . f_{C}, for example, for C=80 bands or C=128 bands, or any other number of bands. In some embodiments, the bands may be mel-bands and the spectrograms may be mel-spectrograms.

Spectrograms of input speech 310 may be converted into digital representation of speech (input embeddings) that may be processed by a trained DSTM 120. In some embodiments, the input embeddings may be obtained using a suitable waveform-to-embedding converter (tokenizer), e.g., Wav2vec converter or any other similar converter.

DSTM 120 may have a mirrored (duplex) architecture with any even number of blocks of neuron layers. For example, DSTM 120 may include a left portion and a right portion. The left portion may include blocks 320-1 . . . 320-N and the right portion may include blocks 321-N . . . 321-1. Each block 320-k may include any number of neuron layers or multi-layer modules. FIG. 3 depicts schematically blocks having four neuron modules per block, but the number of modules need not be so limited. Each block 320-k in the left portion may have a symmetric counterpart block 321-k in the right portion, which may be a mirror image of block 320-k and vice versa. A given block A should be understood as a mirror image of block B provided that a neuron arrangement (e.g., neuron types and connection topology) of block A is a mirror reflection (with respect to central plane 330 of DSTM 120) of a neuron arrangement of block B. Nonetheless, since DSTM 120 is trained to process different language speech utterances in a first direction (e.g., left-to-right) and in a second direction (e.g., right-to-left), specific learned parameters of block A (e.g., weights and biases) need not be the same as learned parameters of block B. FIG. 3 illustrates an example implementation where different blocks 320-1 . . . 320-N (and, correspondingly, blocks 321-N . . . 321-1) have the same architecture. In other implementations, any, some, or all blocks 320-1 . . . 320-N (and, correspondingly, blocks 321-N . . . 321-1) may have different architectures.

In one example implementation, an architecture of block 320-1, illustrated with the callout portion of FIG. 3, may be of a conformer type. The conformer architecture combines elements of transformer networks (such as self-attention layers) with elements of convolutional networks (such as layers with kernels to support narrowing and/or broadening field of perception). More specifically, an example conformer architecture of block 320-1 may include a feed-forward (FF) module 322, a self-attention (SA) module 324, a convolutional (CN) module 326, and another feed-forward module 328. The example architecture of block 320-1 operating in the first direction may further include a plurality of adders 332 that implement residual connections by splitting block inputs and recombining block outputs. For example, an input (e.g., vector input) x into block 320-1 may be split into two portions x=[x⁽¹⁾, x⁽²⁾]. Block 320-1 may perform mapping x→z of the input x to an output z=[z⁽¹⁾, z⁽²⁾]. More specifically, the feed-forward module 322 computes a first portion of the intermediate output y=[y⁽¹⁾, y⁽²⁾],

$${y}^{( 1 )} = {x}^{( 1 )} + FF ( {x}^{( 2 )} ) ,$$

while the self-attention module 324 computes a second portion of the intermediate output,

$${y}^{( 2 )} = {x}^{( 2 )} + SA ( {y}^{( 1 )} ) .$$

The final block outputs are then computed using the intermediate output(s), e.g., by using the convolutional module 326 to obtain a first portion of the final output,

$${z}^{( 1 )} = {y}^{( 1 )} + CN ( {y}^{( 2 )} ) ,$$

and using the feed-forward module 328 to obtain a second portion of the final output,

$${z}^{( 2 )} = {y}^{( 2 )} + FF ( {z}^{( 1 )} ) .$$

Operations of block 320-1 in the second (reverse) direction include subtractors 334 instead of adders 332. More specifically, the feed-forward module 328 computes the second portion of the intermediate output,

$${y}^{( 2 )} = {z}^{( 2 )} - FF ( {z}^{( 1 )} ) ,$$

while the convolutional module 326 computes the first portion of the intermediate output,

$${y}^{( 1 )} = {z}^{( 1 )} - CN ( {y}^{( 2 )} ) .$$

The final block outputs are computed from the intermediate output(s), e.g., by using the self-attention module 324 to obtain the second portion of the final output,

$${x}^{( 2 )} = {y}^{( 2 )} - SA ( {y}^{( 1 )} ) ,$$

and using the feed-forward module 322 to obtain the first portion of the final output,

$${x}^{( 1 )} = {y}^{( 1 )} - FF ( {x}^{( 2 )} ) .$$

In some implementations, each feed-forward module (e.g., 322, 328) may include one or more linear layers, one or more dropout layers, and a layer of activation. The activation layer may use a sigmoid activation function or some other suitable activation function. In some implementations, the activation layer may be inserted between two linear layers.

In some implementations, the self-attention module 324 may include one or more attention layers and one or more linear layers. In some implementations, the self-attention module 324 may also include one or more dropout layers. In some implementations, the self-attention module 324 may include multiple attention heads. In some implementations, the self-attention module 324 may use positional embeddings as additional inputs. In some implementations, the self-attention module 324 may be extended to include cross-attention where an encoded representation of input speech 301 (or input speech 303) is used in key-value pairs for a decoded representation of output speech 301-T that is being used as queries.

In some implementations, the convolutional module 324 may use multiple types of convolutions, e.g., pointwise convolutions and one-dimensional (1D) depthwise convolutions, to capture local-range dependencies of input speech 301 (or input speech 303). In some implementations, the convolutional module 324 may further include one or more dropout layers, one or more batch normalization layers, one or more dropout layers, and one or more activation layers. In some implementations, different activation layers of the convolutional module 324 may deploy different activation functions, e.g., the Glu Dauphin activation function and the Swish Ramachandran activation function, or some other suitable activation function(s).

Deploying both convolutional layers and attention layers accounts for both local speech context (short-range or local-range correlations between different speech phonemes and words), captured by the convolutional layers, and global speech context (long-range correlations between more distant words and sentences), captured by the attention layers.

Evaluation (inference) processing of input speech 301 by DSTM 120 generates final state features (embeddings) of output speech 301-T in the second language. (Output speech 301-T represents a translation of input speech 301 to the second language.) The final state features represent units of output speech 301-T (phonemes, words, phrases, sentences, and/or the like) which are processed by a suitable vocoder to generate spectrograms of output speech 301-T. The spectrograms may then be used to generate speech waveforms that can be perceived by human ear.

Operations of DSTM 120 may be similarly performed in the second direction. For example, input speech 303 in the second language may undergo preprocessing 311 (which may be performed similarly to preprocessing 310). Speech embeddings representing input speech 303 may then be processed by DSTM 120 in the second direction to generate output embeddings of output speech 303-T in the first language (which represents the translation of input speech 303-T to the first language), which are then converted to waveforms of output speech 303-T, e.g., using a suitable vocoder in the second language.

Training of DSTM 120 may be performed in multiple stages, e.g., one or more stages of noiseless training and one or more stages of diffusion (noisy) training. During a noiseless training stage, DSTM 120 operating in the first direction may be trained to generate an unknown (to DSTM 120) target utterance x in the first language (e.g., input speech 301), given a known training utterance y (e.g., output speech 301-T) in the second language. Likewise, DSTM 120, still operating in the first direction, may further be trained to generate target utterance y (e.g., output speech 301-T) in the second language, given known training utterance x (e.g., input speech 301) in the first language.

Similarly, DSTM 120 operating in the second direction can be trained to generate an unknown target utterance y′ (e.g., input speech 303) in the second language given a known training utterance x′ (e.g., output speech 303-T) in the first language. Likewise, DSTM 120, still operating in the second direction may further be trained to generate target utterance x′ (e.g., output speech 303-T) in the first language given training utterance y′ (e.g., input speech 303) in the second language. At least for some of the training runs, x′=x and y′=y, so that DSTM 120 learns to perform reversible translations x→y and y→x.

For higher efficiency and stability of DSTM 120, diffusion stage(s) of training may include adding noise to distort target outputs. For example, with DSTM 120 operating in the first direction, a target utterance x₀ (e.g., input speech 301) may be distorted with a randomly sampled noise ϵₓ into a noisy utterance xₙ, e.g.,

$${x}_{n} = \sqrt{1 - β} {x}_{0} + \sqrt{β} {ϵ}_{x} .$$

Noise ϵₓ may be a vector of the same dimensionality as utterance x₀. Noise ϵₓ may be sampled from a Gaussian (normal) distribution. For example, a number of noise sampling epochs N may be randomly selected (e.g., with a uniform probability) from a range N∈[1,Nₘₐₓ], where the maximum number Nₘₐₓ may be 5, 8, 10, or any other number. During each epoch, an amount of noise is added to the utterance causing the utterance to evolve from the initial (noiseless) value x₀ towards the noise-distorted value x_{N}: x₀→x₁→x₂→ . . . →x_{N}. Each transition xⱼ₋₁→xⱼ occurs probabilistically from a given (by the previous epoch) value xⱼ₋₁ to a new stochastic value xⱼ, e.g., by randomly selecting the variance βⱼ of the Gaussian distribution which then samples this stochastic value xⱼ according to (in one non-limiting example) the following conditional probability for the jth epoch,

$$q ( {x}_{j} \vert {x}_{j - 1} ) = 𝒩 ( {x}_{j} , \sqrt{1 - {β}_{j}} {x}_{j - 1} , \sqrt{{β}_{j}} I ) ,$$

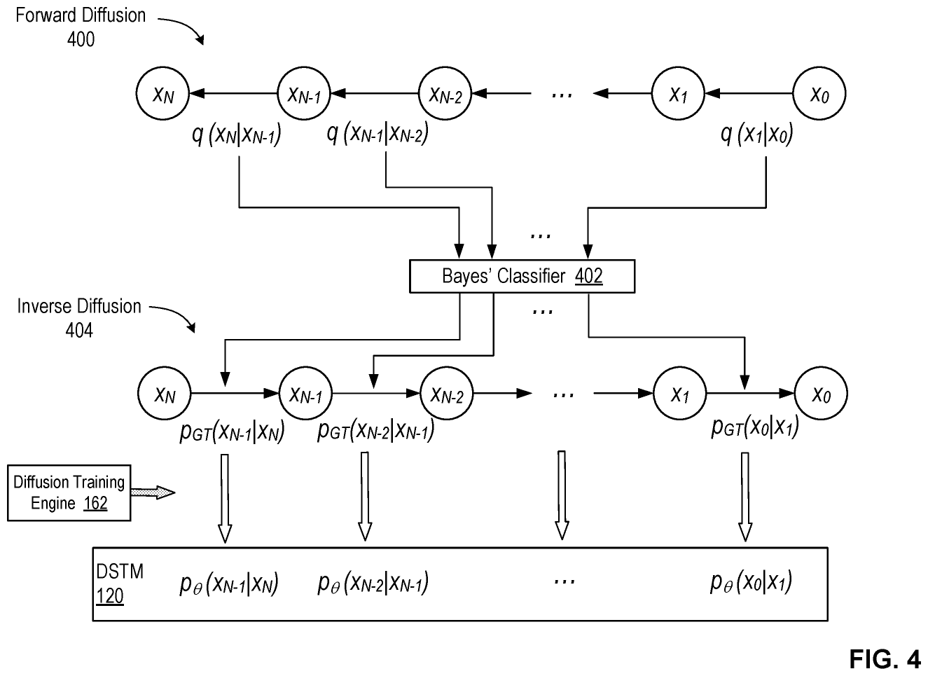

namely from the Gaussian distribution centered at \sqrt{1−βⱼ}xⱼ₋₁ and having variance \sqrt{βⱼ}. FIG. 4 illustrates evolution of a noise training utterance over N noise sampling epochs, for training of a duplex model capable of reversible speech-to-speech translations, according to at least one embodiment. The combined probability of reaching the final noisy utterance x_{N} is given by the product of all conditional probabilities,

$$q ( {x}_{1 … N} \vert {x}_{0} ) = q ( {x}_{N} \vert {x}_{N - 1} ) q ( {x}_{N - 1} \vert {x}_{N - 2} ) … q ( {x}_{1} \vert {x}_{0} ) ,$$

which represents forward diffusion 400.

During the noisy stage(s) of training, DSTM 120 learns how to recover target utterance x₀ from distorted utterance xₙ. This amounts to performing the reverse diffusion reconstruction:

$${p}_{θ} ( {x}_{0 … N} ) = {p}_{θ} ( {x}_{0} \vert {x}_{1} ) {p}_{θ} ( {x}_{1} \vert {x}_{2} ) … {p}_{θ} ( {x}_{N - 1} \vert {x}_{N} ) p ( {x}_{N} ) ,$$

where p(x_{N}) is a known distribution of the final distorted utterances and p_{θ}(xⱼ₋₁|xⱼ) is a distribution that DSTM 120 learns during training, with θ denoting a set of learned parameters (e.g., weights and biases). For each step p_{θ}(xⱼ₋₁|xⱼ), the ground truth distribution p_{GT} (xⱼ₋₁|xⱼ) may be obtained using Bayes' classifier 402,

$${p}_{GT} ( {x}_{j - 1} \vert {x}_{j} ) = \frac{q ( {x}_{j} \vert {x}_{j - 1} ) q ( {x}_{j - 1} )}{q ( {x}_{j} )}$$

that determines conditional probability of xⱼ₋₁ given xⱼ (of the reverse diffusion process) in terms of the conditional probability of xⱼ given xⱼ₋₁ (of the forward diffusion process) and the total probabilities of occurrence of q(xⱼ) (and, similarly, q(xⱼ₋₁)), which may be computed, e.g., by summing (integrating) over all diffusion trajectories (all intermediate values xⱼ₋₁, xⱼ₋₂, . . . x₁),

$$q ( {x}_{j} ) = \int q ( {x}_{j} \vert {x}_{j - 1} ) {\prod }_{k = 1}^{j - 1} q ( {x}_{j - k} \vert {x}_{j - k - 1} ) {dx}_{j - k} .$$

During the noisy stage(s) of training, training engine 126 uses ground truth distributions p_{GT}(xⱼ₋₁|xⱼ) to train DSTM 120 to identify model distributions p_{θ}(xⱼ₋₁|xⱼ) that implement correct inverse diffusion 404. In some embodiments, the model distributions may be taken as the Gaussian distributions,

$${p}_{θ} ( {x}_{j - 1} \vert {x}_{j} ) = 𝒩 ( {x}_{j - 1} , {μ}_{j} ( θ ) , {\sum }_{j} ( θ ) ) ,$$

with learned mean μⱼ(θ) and average Σⱼ(θ).

In some embodiments, training engine 126 may use the Kullback-Liebler divergence as a loss function to evaluate mismatch between predicted distributions pa(x_₁|xⱼ) and the ground truth distributions p_{GT}(xⱼ₋₁|xⱼ). During training, parameters θ of DSTM 120 are changed to reduce the loss function.

In some embodiments, the noise-distorted x_{N} (and its digital representations) may be treated as the subject of attention key-value pairs in the self-attention modules (e.g., modules 324 in FIG. 3) of DSTM 120 with training utterance y₀ treated as the query. In some embodiments, the noise ϵₓ may be predicted directly from the distorted x_{N} with the training utterance y₀ being treated as the conditional variable.

Similarly, with DSTM 120 operating in the second direction, training may include recovering, from a noise-distorted y_{N} in the second language and the corresponding (undistorted) utterance x₀ in the first language, the undistorted target utterance y₀ in the second language (or, equivalently, the noise ϵ_{y} used to distort the target utterance). Training in the first direction and in the second direction may be alternated, so that the duplex model learns the full cycle consistency of reversible translations.

One or more loss functions may be used to train DSTM 120. In some embodiments, a mean square average loss may be computed for predicted noises Eₓ and E_{y} in relation to the ground truth losses eₓ and ϵ_{y}, e.g., L₁=λ₁∥Eₓ−eₓ∥²+λ₂∥E_{y}−ϵ_{y}∥². In some embodiments, the Connectionist Temporal Classification (CTC) loss function may be used to align output speech utterances with target speech utterances. Another loss function may be used to evaluate accuracy of forward-backward translations, x→y→\tilde{x}, e.g., by computing a misalignment between the predicted forward-backward translation \tilde{x} and the original translation x: L₂=1−cos(\tilde{x}·x). Yet another loss function may be a cross-entropy loss function for predicted units of output speech and/or spectrograms of the output speech.

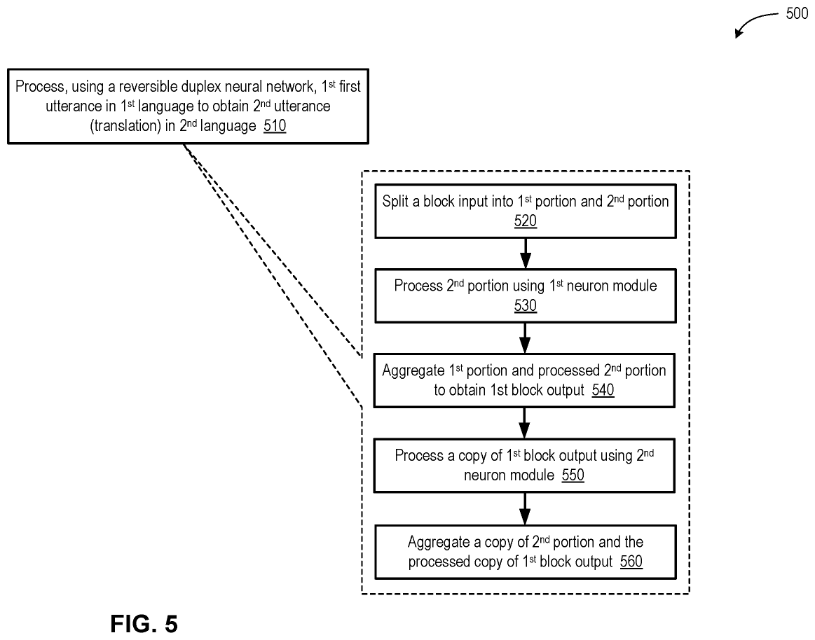

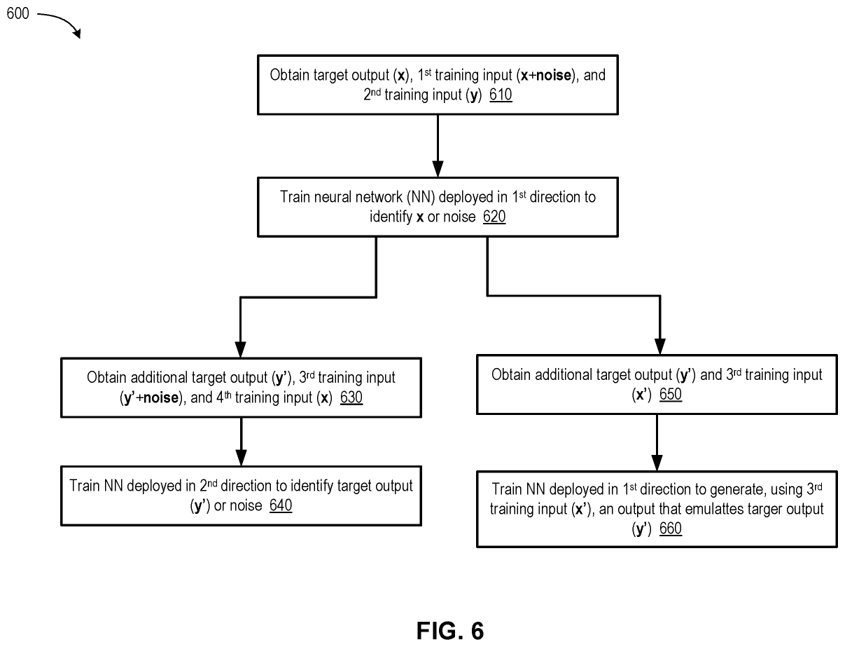

FIG. 5 and FIG. 6 are flow diagrams of example methods 500 and 600 of using and training duplex models capable of reversible translations of speech utterances between different languages, according to at least one embodiment. Methods 500 and 600 may involve speech utterances produced by people or machines in any possible context, e.g., a conversation, a public speech, a public event, a business meeting, a conference, a street encounter, an interaction in a game, an interaction with a chatbot or digital avatar, an interaction with an in-vehicle infotainment system, and/or the like. Methods 500 and 600 may be performed using one or more processing units (e.g., CPUs, GPUs, accelerators, PPUs, DPUs, etc.), which may include (or communicate with) one or more memory devices. In at least one embodiment, methods 500 and/or 600 may be performed using processing units of inference server 102 and/or training server 160. In at least one embodiment, processing units performing methods 500 and/or 600 may be executing instructions stored on a non-transient computer-readable storage media. In at least one embodiment, methods 500 and/or 600 may be performed using multiple processing threads (e.g., CPU threads and/or GPU threads), individual threads executing one or more individual functions, routines, subroutines, or operations of the method. In at least one embodiment, processing threads implementing methods 500 and/or 600 may be synchronized (e.g., using semaphores, critical sections, and/or other thread synchronization mechanisms). Alternatively, processing threads implementing methods 500 and/or 600 may be executed asynchronously with respect to each other. Various operations of methods 500 and/or 600 may be performed in a different order compared with the order shown in FIG. 5 and/or FIG. 6. Some operations of methods 500 and/or 600 may be performed concurrently with other operations. In at least one embodiment, one or more operations shown in FIG. 5 and/or FIG. 6 may not always be performed.

FIG. 5 is a flow diagram of an example method 500 of using a duplex model capable of reversible translations of speech utterances, according to at least one embodiment. Method 500 may be performed by processing units of training server 160. At block 510, processing units executing method 500 may process, using a duplex neural network (NN) (e.g., DSTM 120) deployed in a first direction, a first representation of a first speech utterance (e.g., input speech 301 in FIG. 3) in a first language to obtain a second representation of a second speech utterance (e.g., output speech 301-T) in a second language. The second speech utterance may be or include a translation of the first speech utterance to the second language. In some embodiments, the duplex NN may include a first subnetwork (e.g., blocks 320-1 . . . 320-N) and a second subnetwork (e.g., blocks 321-N . . . 321-1), an architecture of the first subnetwork being a mirror image of an architecture of the second subnetwork. In some embodiments, the duplex NN may be trained to process, in a second direction, the second representation to obtain the first representation. For example, if output speech 301-T is used as input speech 303 into the NN, the output speech 303-T may be the same as input speech 301 or substantially the same as input speech 301, up to small differences that do not change a semantic meaning of the output speech. In some embodiments, the first (second) representation may include a set of embeddings obtained by processing, using an embeddings network (e.g., Wav2vec or a similar network), a set of spectrograms for the first (second) speech utterance in the first (second) language.

In some embodiments, the duplex NN may have a conformer NN architecture. In some embodiments, the first subnetwork may include one or more attention layers. In some embodiments, the first subnetwork may include one or more neuron blocks having two or more of: a fully-connected layer, a convolutional layer, a self-attention layer, or a normalization layer.

In some embodiments, the first (second) subnetwork may include one or more neuron blocks (e.g., blocks 320-1 . . . 320-N and/or blocks 321-N . . . 321-1) that perform the following operations. At block 520, the operations of a neuron block may include splitting a block input into a first portion and a second portion (e.g., x⁽¹⁾ and x⁽²⁾, if the NN is operating in the first direction, and/or y⁽¹⁾ and y⁽²⁾, if the NN is operating in the second direction, with reference to FIG. 3).

At block 530, the operations of the neuron block may include processing, using a first neuron module of the neuron block (e.g., FF module 322/CN module 326, if the NN is operating in the first direction, and/or SA module 324/FF module 328, if the NN is operating in the second direction) the second portion.

At block 540, the operations of the neuron block may further include aggregating (e.g., using addition/subtraction operations) the first portion and the processed second portion to obtain a first block output (e.g., y⁽¹⁾ or z⁽¹⁾, if the NN is operating in the first direction, and/or y⁽¹⁾ or x⁽¹⁾, if the NN is operating in the second direction).

At block 550, the operations of the neuron block may further include processing, using a second neuron module of the neuron block (e.g., SA module 324/FF module 328, if the NN is operating in the first direction, and/or CN module 326/FF module 322, if the NN is operating in the second direction), a copy of the first block output.

At block 560, the operations of the neuron block may further include aggregating a copy of the second portion (e.g., x⁽²⁾ or y⁽²⁾, if the NN is operating in the first direction, and/or y⁽²⁾ or x⁽²⁾, if the NN is operating in the second direction) and the processed copy of the first block output (e.g., output of SA module 324 or FF module 328, if the NN is operating in the first direction, and/or output of CN module 326/FF module 322, if the NN is operating in the second direction) to obtain a second block output (e.g., y⁽²⁾ or z⁽²⁾, if the NN is operating in the first direction, and/or y⁽²⁾ or x⁽²⁾, if the NN is operating in the second direction).

FIG. 6 is a flow diagram of an example method 600 of training a duplex model capable of reversible translations of speech utterances, according to at least one embodiment. Method 600 may be performed by processing units of training server 160. The NN trained using method 600 may include a duplex NN that has a first subnetwork and a second subnetwork, an architecture of the first subnetwork being a mirror image of an architecture of the second subnetwork. In some embodiments, the duplex NN may have a conformer NN architecture.

At block 610, the processing units performing method 600 may obtain training data that includes a target output, a first training input, and a second training input. The target output may include a first representation of a first speech utterance (e.g., x₀) in a first language. The first training input may include the target output distorted by a first noise (e.g., symbolically, x₀+ϵₓ). The second training input may include a second representation of a second speech utterance (e.g., y₀) in a second language, such that the second speech utterance is or includes a translation of the first speech utterance to the second language. In some embodiments, the first noise (e.g., symbolically, ϵₓ) may be sampled from a random distribution (e.g., Gaussian distribution or any other suitable distribution). At block 620, the processing units may train the NN deployed in a first direction to identify, using the first training input and the second training input, at least one of the target output (e.g., x₀) or the first noise (e.g., ϵₓ).

At block 630, method 600 may continue with obtaining additional training data that includes an additional target output, a third training input, and a fourth training input. The additional target output may include a third representation of a third speech utterance (e.g., y′₀) in the second language. The third training input may include the additional target output distorted by a second noise (e.g., symbolically, y′₀+ϵ_{y}). The fourth training input may include a fourth representation of a fourth speech utterance (e.g., x′₀) in the first language. The fourth speech utterance may be or include a translation of the third speech utterance to the second language. At block 640, method 600 may include training the NN deployed in a second direction to identify, using the third training input and the fourth training input, at least one of a difference between the additional target output (e.g., y′₀) or the second noise (e.g., ϵ_{y}).

Method 600 may also include one more stages of training that are performed using noise-free training data. For example, at block 650, method 600 may continue with obtaining additional training data that includes a third training input and an additional target output. The third training input may include a third representation of a third speech utterance (e.g., x″) in the first language. The additional target output may include a fourth representation of a fourth speech utterance (e.g., y″) in the second language. The fourth speech utterance may be or include a translation of the third speech utterance to the second language. At block 660, method 600 may include training the NN deployed in the first direction to generate, using the third training input, an output that emulates the additional target output.

The systems and methods described herein may be used for a variety of purposes, by way of example and without limitation, for performing one or more operations with respect to machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., an in-vehicle infotainment system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### Inference and Training Logic

In at least one embodiment, inference and/or training logic may include, without limitation, a first code and/or data storage to store forward and/or output weight and/or input/output data, and/or other parameters to configure neurons or layers of a neural network trained and/or used for inferencing in aspects of one or more embodiments. In at least one embodiment, the training logic may include (or be coupled to code and/or data storage that stores) graph code or other software to control timing and/or order, in which weight and/or other parameter information is to be loaded to configure processing units, including logic units, integer and/or floating point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, the first code and/or data storage stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of the first code and/or data storage may be included with other on-chip or off-chip data storage, including a processor's L1, L2, or L3 cache or system memory.

In at least one embodiment, any portion of the first code and/or data storage may be internal or external to one or more processors or other hardware logic devices or circuits. In at least one embodiment, the first code and/or data storage may be cache memory, dynamic randomly addressable memory (“DRAM”), static randomly addressable memory (“SRAM”), non-volatile memory (e.g., flash memory), or other storage. In at least one embodiment, a choice of whether the first code and/or data storage is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, the inference and/or training logic may include, without limitation, a second code and/or data storage to store backward and/or output weight and/or input/output data corresponding to neurons or layers of a neural network trained and/or used for inferencing in aspects of one or more embodiments. In at least one embodiment, the second code and/or data storage stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, the training logic may include (or be coupled to the second code and/or data storage that stores) graph code or other software to control timing and/or order, in which weight and/or other parameter information is to be loaded to configure processing units, including logic units, integer and/or floating point units (collectively, arithmetic logic units (ALUs)).

In at least one embodiment, code, such as graph code, causes the loading of weight or other parameter information into processor ALUs based on an architecture of a neural network to which such code corresponds. In at least one embodiment, any portion of the second code and/or data storage may be included with other on-chip or off-chip data storage, including a processor's L1, L2, or L3 cache or system memory. In at least one embodiment, any portion of the second code and/or data storage may be internal or external to one or more processors or other hardware logic devices or circuits. In at least one embodiment, the second code and/or data storage may be cache memory, DRAM, SRAM, non-volatile memory (e.g., flash memory), or other storage. In at least one embodiment, a choice of whether the second code and/or data storage is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, the first code and/or data storage and the second code and/or data storage may be separate storage structures. In at least one embodiment, the first code and/or data storage and the second code and/or data storage may be a combined storage structure. In at least one embodiment, the first code and/or data storage and the second code and/or data storage may be partially combined and partially separate. In at least one embodiment, any portion of the first code and/or data storage and the second code and/or data storage may be included with other on-chip or off-chip data storage, including a processor's L1, L2, or L3 cache or system memory.

In at least one embodiment, the inference and/or training logic may include, without limitation, one or more arithmetic logic unit(s) (“ALU(s)”), including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage that are functions of input/output and/or weight parameter data stored in the first code and/or data storage and/or the second code and/or data storage. In at least one embodiment, activations stored in the activation storage are generated according to linear algebraic and or matrix-based mathematics performed by ALU(s) in response to performing instructions or other code, wherein weight values stored in the first code and/or data storage and/or the second code and/or data storage are used as operands along with other values, such as bias values, gradient information, momentum values, or other parameters or hyperparameters, any or all of which may be stored in code and/or the first data storage or code and/or the second data storage or another storage on or off-chip.

In at least one embodiment, ALU(s) are included within one or more processors or other hardware logic devices or circuits, whereas in another embodiment, ALU(s) may be external to a processor or other hardware logic device or circuit that uses them (e.g., a co-processor). In at least one embodiment, ALU(s) may be included within a processor's execution units or otherwise within a bank of ALUs accessible by a processor's execution units either within the same processor or distributed between different processors of different types (e.g., central processing units, graphics processing units, fixed function units, etc.). In at least one embodiment, the first code and/or data storage, code and/or the second data storage, and activation storage may share a processor or other hardware logic device or circuit, whereas in another embodiment, they may be in different processors or other hardware logic devices or circuits, or some combination of same and different processors or other hardware logic devices or circuits. In at least one embodiment, any portion of the activation storage may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, the activation storage may be cache memory, DRAM, SRAM, non-volatile memory (e.g., flash memory), or other storage. In at least one embodiment, the activation storage may be completely or partially within or external to one or more processors or other logical circuits. In at least one embodiment, a choice of whether the activation storage is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic may be used in conjunction with central processing unit (“CPU”) hardware, graphics processing unit (“GPU”) hardware or other hardware, such as field programmable gate arrays (“FPGAs”).

In at least one embodiment, inference and/or training logic may include, without limitation, hardware logic in which computational resources are dedicated or otherwise exclusively used in conjunction with weight values or other information corresponding to one or more layers of neurons within a neural network. In at least one embodiment, inference and/or training logic may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, the inference and/or training logic may be used in conjunction with central processing unit (CPU) hardware, graphics processing unit (GPU) hardware or other hardware, such as field programmable gate arrays (FPGAs). In at least one embodiment, the inference and/or training logic includes, without limitation, the first code and/or data storage and the second code and/or data storage, which may be used to store code (e.g., graph code), weight values and/or other information, including bias values, gradient information, momentum values, and/or other parameter or hyperparameter information. In at least one embodiment, each of the first code and/or data storage and the second code and/or data storage is associated with a dedicated computational resource, such as computational hardware and computational hardware, respectively. In at least one embodiment, each of the computational hardware and computational hardware comprises one or more ALUs that perform mathematical functions, such as linear algebraic functions, only on information stored in code and/or data storage and code and/or data storage, respectively, the result of which is stored in activation storage.

In at least one embodiment, each of code and/or data storages and the corresponding computational hardware, respectively, correspond to different layers of a neural network, such that resulting activation from one storage/computational pair of the first code and/or data storage and first computational hardware is provided as an input to a next storage/computational pair of the second code and/or data storage and computational hardware, in order to mirror a conceptual organization of a neural network. In at least one embodiment, each of the multiple storage/computational pairs and may correspond to more than one neural network layer. In at least one embodiment, additional storage/computation pairs (not shown) subsequent to or in parallel with the storage/computation pairs may be included in the inference and/or training logic.

### Neural Network Training and Deployment

In at least one embodiment, untrained neural network is trained using a training dataset. In at least one embodiment, training framework is a PyTorch framework, whereas in other embodiments, training framework is a TensorFlow, Boost, Caffe, Microsoft Cognitive Toolkit/CNTK, MXNet, Chainer, Keras, Deeplearning4j, or other training framework. In at least one embodiment, training framework 804 trains an untrained neural network and enables it to be trained using processing resources described herein to generate a trained neural network. In at least one embodiment, weights may be chosen randomly or by pre-training using a deep belief network. In at least one embodiment, training may be performed in either a supervised, partially supervised, or unsupervised manner.

In at least one embodiment, the untrained neural network is trained using supervised learning, wherein the training dataset includes an input paired with a desired output for an input, or where the training dataset includes input having a known output and an output of the neural network is manually graded. In at least one embodiment, the untrained neural network is trained in a supervised manner and processes inputs from the training dataset and compares resulting outputs against a set of expected or desired outputs. In at least one embodiment, errors are then propagated back through the untrained neural network. In at least one embodiment, training framework 804 adjusts weights that control the untrained neural network. In at least one embodiment, the training framework includes tools to monitor how well the untrained neural network is converging towards a model, such as trained neural network, suitable to generating correct answers, such as in a given result, based on input data such as a new dataset. In at least one embodiment, the training framework trains the untrained neural network repeatedly while adjusting weights to refine an output of the untrained neural network using a loss function and adjustment algorithm, such as stochastic gradient descent. In at least one embodiment, the training framework trains the untrained neural network until the untrained neural network achieves a desired accuracy. In at least one embodiment, the trained neural network can then be deployed to implement any number of machine learning operations.

In at least one embodiment, the untrained neural network is trained using unsupervised learning, wherein the untrained neural network attempts to train itself using unlabeled data. In at least one embodiment, unsupervised learning the training dataset will include input data without any associated output data or “ground truth” data. In at least one embodiment, the untrained neural network can learn groupings within the training dataset and can determine how individual inputs are related to the untrained dataset. In at least one embodiment, unsupervised training can be used to generate a self-organizing map the in trained neural network capable of performing operations useful in reducing dimensionality of the new dataset. In at least one embodiment, unsupervised training can also be used to perform anomaly detection, which allows identification of data points in the new dataset that deviate from normal patterns of the new dataset.

In at least one embodiment, semi-supervised learning may be used, which is a technique in which the training dataset includes a mix of labeled and unlabeled data. In at least one embodiment, the training framework may be used to perform incremental learning, such as through transferred learning techniques. In at least one embodiment, incremental learning enables the trained neural network to adapt to the new dataset without forgetting knowledge instilled within the trained neural network during initial training.

In at least one embodiment, a suitable process may be deployed to perform game name recognition analysis and inferencing on user feedback data at one or more facilities, such as a data center.

In at least one embodiment, such process may be executed within a training system and/or a deployment system. In at least one embodiment, the training system may be used to perform training, deployment, and embodiment of machine learning models (e.g., neural networks, object detection algorithms, computer vision algorithms, etc.) for use in the deployment system. In at least one embodiment, the deployment system may be configured to offload processing and compute resources among a distributed computing environment to reduce infrastructure requirements at a given facility. In at least one embodiment, the deployment system may provide a streamlined platform for selecting, customizing, and implementing virtual instruments for use with computing devices at the facility. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of the deployment system during execution of applications.

In at least one embodiment, some applications used in advanced processing and inferencing pipelines may use machine learning models or other AI to perform one or more processing steps. In at least one embodiment, machine learning models may be trained at the facility using the feedback data (such as imaging data) stored at facility or feedback data from another facility or facilities, or a combination thereof. In at least one embodiment, the training system may be used to provide applications, services, and/or other resources for generating working, deployable machine learning models for deployment system.

In at least one embodiment, a model registry may be backed by object storage that may support versioning and object metadata. In at least one embodiment, object storage may be accessible through, for example, a cloud storage compatible application programming interface (API) from within a cloud platform. In at least one embodiment, machine learning models within the model registry may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline may include a scenario where the facility is training their own machine learning model or has an existing machine learning model that needs to be optimized or updated. In at least one embodiment, the feedback data may be received from various channels, such as forums, web forms, or the like. In at least one embodiment, once the feedback data is received, AI-assisted annotation may be used to aid in generating annotations corresponding to the feedback data to be used as ground truth data for a machine learning model. In at least one embodiment, the AI-assisted annotation may include one or more machine learning models (e.g., convolutional neural networks (CNNs)) that may be trained to generate annotations corresponding to certain types of the feedback data (e.g., from certain devices) and/or certain types of anomalies in feedback data. In at least one embodiment, the AI-assisted annotations may then be used directly, or may be adjusted or fine-tuned using an annotation tool, to generate ground truth data. In at least one embodiment, in some examples, labeled data may be used as ground truth data for training a machine learning model. In at least one embodiment, AI-assisted annotations, labeled data, or a combination thereof may be used as ground truth data for training a machine learning model, e.g., via model training. In at least one embodiment, a trained machine learning model may be referred to as an output model, and may be used by a deployment system, as described herein.

In at least one embodiment, training pipeline may include a scenario where a facility needs a machine learning model for use in performing one or more processing tasks for one or more applications in the deployment system, but the facility may not currently have such a machine learning model (or may not have a model that is optimized, efficient, or effective for such purposes). In at least one embodiment, an existing machine learning model may be selected from a model registry. In at least one embodiment, the model registry may include machine learning models trained to perform a variety of different inference tasks on imaging data. In at least one embodiment, machine learning models in the model registry may have been trained on imaging data from different facilities than facility (e.g., facilities that are remotely located). In at least one embodiment, machine learning models may have been trained on imaging data from one location, two locations, or any number of locations. In at least one embodiment, when being trained on imaging data, which may be a form of the feedback data, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to the model registry. In at least one embodiment, a machine learning model may then be retrained, or updated, at any number of other facilities, and a retrained or updated model may be made available in the model registry. In at least one embodiment, a machine learning model may then be selected from the model registry- and referred to as an output model- and may be used in deployment system to perform one or more processing tasks for one or more applications of a deployment system.

In at least one embodiment, training pipeline may be used in a scenario that includes a facility requiring a machine learning model for use in performing one or more processing tasks for one or more applications in the deployment system, but facility may not currently have such a machine learning model (or may not have a model that is optimized, efficient, or effective for such purposes). In at least one embodiment, a machine learning model selected from the model registry might not be fine-tuned or optimized for the feedback data generated at the facility because of differences in populations, genetic variations, robustness of training data used to train a machine learning model, diversity in anomalies of training data, and/or other issues with training data. In at least one embodiment, the AI-assisted annotation may be used to aid in generating annotations corresponding to feedback data to be used as ground truth data for retraining or updating a machine learning model. In at least one embodiment, labeled data may be used as ground truth data for training a machine learning model. In at least one embodiment, retraining or updating a machine learning model may be referred to as model training. In at least one embodiment, the model training may include data—e.g., AI-assisted annotations, labeled data, or a combination thereof—that may be used as ground truth data for retraining or updating a machine learning model.

In at least one embodiment, the deployment system may include software, services, hardware, and/or other components, features, and functionality. In at least one embodiment, deployment system may include a software “stack,” such that the software may be built on top of the services and may use the services to perform some or all of processing tasks, and the services and the software may be built on top of the hardware and use the hardware to execute processing, storage, and/or other compute tasks of deployment system.

In at least one embodiment, the software may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to the feedback data (or other data types, such as those described herein). In at least one embodiment, an advanced processing and inferencing pipeline may be defined based on selections of different containers that are desired or required for processing feedback data, in addition to containers that receive and configure imaging data for use by each container and/or for use by the facility after processing through a pipeline (e.g., to convert outputs back to a usable data type for storage and display at the facility). In at least one embodiment, a combination of containers within the software (e.g., that make up a pipeline) may be referred to as a virtual instrument (as described in more detail herein), and a virtual instrument may leverage the services and the hardware to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include the output models of the training system.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in the model registry and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services as a system for deploying a deployment pipeline. In at least one embodiment, once validated by the system (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system for deploying a deployment pipeline. In at least one embodiment, completed and validated applications or containers may be stored in a container registry and associated machine learning models may be stored in model registry. In at least one embodiment, a requesting entity that provides an inference or image processing request may browse a container registry and/or model registry for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of the deployment system (e.g., a cloud) to perform processing of a data processing pipeline. In at least one embodiment, processing by the deployment system may include referencing selected elements (e.g., applications, containers, models, etc.) from a container registry and/or the model registry. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, the services may be leveraged. In at least one embodiment, the services may include compute services, collaborative content creation services, simulation services, artificial intelligence (AI) services, visualization services, and/or other service types. In at least one embodiment, the services may provide functionality that is common to one or more applications in software, so functionality may be abstracted to a service that may be called upon or leveraged by applications. In at least one embodiment, functionality provided by the services may run dynamically and more efficiently, while also scaling well by allowing applications to process data in parallel, e.g., using a parallel computing platform. In at least one embodiment, rather than each application that shares a same functionality offered by the service being required to have a respective instance of the service, the service may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more processing operations associated with segmentation tasks. In at least one embodiment, software implementing advanced processing and inferencing pipeline may be streamlined because each application may call upon the same inference service to perform one or more inferencing tasks.

In at least one embodiment, the hardware may include GPUs, CPUs, graphics cards, an AI/deep learning system (e.g., an AI supercomputer, such as NVIDIA's DGX™ supercomputer system), a cloud platform, or a combination thereof. In at least one embodiment, different types of the hardware may be used to provide efficient, purpose-built support for software and services in deployment system. In at least one embodiment, use of GPU processing may be implemented for processing locally (e.g., at facility), within an AI/deep learning system, in a cloud system, and/or in other processing components of deployment system to improve efficiency, accuracy, and efficacy of game name recognition.

In at least one embodiment, the software and/or the services may be optimized for GPU processing with respect to deep learning, machine learning, and/or high-performance computing, simulation, and visual computing, as non-limiting examples. In at least one embodiment, at least some of the computing environment of the deployment system and/or the training system may be executed in a datacenter or one or more supercomputers or high performance computing systems, with GPU-optimized software (e.g., hardware and software combination of NVIDIA's DGX™ system). In at least one embodiment, the hardware may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

In at least one embodiment, a system for deploying a deployment pipeline may be used to implement process and/or other processes including advanced processing and inferencing pipelines. In at least one embodiment, the system may include the training system and the deployment system. In at least one embodiment, the training system and the deployment system may be implemented using software, services, and/or hardware, as described herein.

In at least one embodiment, the system for deploying a deployment pipeline (e.g., the training system and/or the deployment system) may be implemented in a cloud computing environment (e.g., using cloud). In at least one embodiment, the system for deploying a deployment pipeline may be implemented locally with respect to a facility, or as a combination of both cloud and local computing resources. In at least one embodiment, access to APIs in cloud may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of the system, may be restricted to a set of public internet service providers (ISPs) that have been vetted or authorized for interaction.

In at least one embodiment, various components of system for deploying a deployment pipeline may communicate between and among one another using any of a variety of different network types, including but not limited to local area networks (LANs) and/or wide area networks (WANs) via wired and/or wireless communication protocols. In at least one embodiment, communication between facilities and components of the system (e.g., for transmitting inference requests, for receiving results of inference requests, etc.) may be communicated over a data bus or data busses, wireless data protocols (e.g., Wi-Fi), wired data protocols (e.g., Ethernet), etc.

In at least one embodiment, the training system may execute training pipelines, similar to those described herein. In at least one embodiment, where one or more machine learning models are to be used in the deployment pipelines by the deployment system, the training pipelines may be used to train or retrain one or more (e.g., pre-trained) models, and/or implement one or more of pre-trained models (e.g., without a need for retraining or updating). In at least one embodiment, as a result of the training pipelines, output model(s) may be generated. In at least one embodiment, the training pipelines may include any number of processing steps, AI-assisted annotation, labeling or annotating of feedback data to generate labeled data, model selection from a model registry, model training, training, retraining, or updating models, and/or other processing steps. In at least one embodiment, for different machine learning models used by the deployment system, different training pipelines may be used. In at least one embodiment, one training pipeline, may be used for a first machine learning model, another training pipeline may be used for a second machine learning model, and yet another training pipeline may be used for a third machine learning model. In at least one embodiment, any combination of tasks within the training system may be used depending on what is required for each respective machine learning model. In at least one embodiment, one or more of machine learning models may already be trained and ready for deployment so machine learning models may not undergo any processing by the training system and may be implemented by the deployment system.

In at least one embodiment, output model(s) and/or pre-trained model(s) may include any types of machine learning models depending on embodiment. In at least one embodiment, and without limitation, machine learning models used by the system for deploying a deployment pipeline may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, the training pipelines may include AI-assisted annotation. In at least one embodiment, labeled data (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 908 (or other data type used by machine learning models), there may be corresponding ground truth data generated by the training system. In at least one embodiment, AI-assisted annotation may be performed as part of the deployment pipelines; either in addition to, or in lieu of, AI-assisted annotation included in training pipelines. In at least one embodiment, system for deploying a deployment pipeline may include a multi-layer platform that may include a software layer (e.g., software) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., a suitable facility. In at least one embodiment, applications may then call or execute one or more services for performing compute, AI, or visualization tasks associated with respective applications, and software and/or services may leverage hardware to perform processing tasks in an effective and efficient manner.

In at least one embodiment, the deployment system may execute the deployment pipelines. In at least one embodiment, the deployment pipelines may include any number of applications that may be sequentially, non-sequentially, or otherwise applied to feedback data (and/or other data types), including AI-assisted annotation, as described above. In at least one embodiment, as described herein, a deployment pipeline for an individual device may be referred to as a virtual instrument for a device. In at least one embodiment, for a single device, there may be more than one deployment pipeline depending on information desired from data generated by a device.

In at least one embodiment, applications available for the deployment pipelines may include any application that may be used for performing processing tasks on feedback data or other data from devices. In at least one embodiment, because various applications may share common image operations, in some embodiments, a data augmentation library (e.g., as one of the services) may be used to accelerate these operations. In at least one embodiment, to avoid bottlenecks of conventional processing approaches that rely on CPU processing, a parallel computing platform may be used for GPU acceleration of these processing tasks.

In at least one embodiment, the deployment system may include a user interface (UI) (e.g., a graphical user interface, a web interface, etc.) that may be used to select applications for inclusion in the deployment pipeline(s), arrange applications, modify or change applications or parameters or constructs thereof, use and interact with the deployment pipeline(s) during set-up and/or deployment, and/or to otherwise interact with the deployment system. In at least one embodiment, although not illustrated with respect to training system, UI 1014 (or a different user interface) may be used for selecting models for use in the deployment system, for selecting models for training, or retraining, in the training system, and/or for otherwise interacting with the training system.

In at least one embodiment, the pipeline manager may be used, in addition to an application orchestration system, to manage interaction between applications or containers of the deployment pipeline(s) and the services and/or hardware. In at least one embodiment, the pipeline manager may be configured to facilitate interactions from application to application, from application to the service, and/or from application or service to the hardware. In at least one embodiment, this is not intended to be limiting, and in some examples the pipeline manager may be included in the services. In at least one embodiment, the application orchestration system (e.g., Kubernetes, DOCKER, etc.) may include a container orchestration system that may group applications into containers as logical units for coordination, management, scaling, and deployment. In at least one embodiment, by associating applications from the deployment pipeline(s) (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by the pipeline manager and the application orchestration system. In at least one embodiment, so long as an expected input and/or output of each container or application is known by a system (e.g., based on constructs of applications or containers), the application orchestration system and/or the pipeline manager may facilitate communication among and between, and sharing of resources among and between, each of the applications or containers. In at least one embodiment, because one or more of applications or containers in the deployment pipeline(s) may share the same services and resources, the application orchestration system may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of the application orchestration system) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services leveraged and shared by applications or containers in the deployment system may include compute services, collaborative content creation services, AI services, simulation services, visualization services, and/or other service types. In at least one embodiment, applications may call (e.g., execute) one or more of the services to perform processing operations for an application. In at least one embodiment, the compute services may be leveraged by applications to perform super-computing or other high-performance computing (HPC) tasks. In at least one embodiment, the compute service(s) may be leveraged to perform parallel processing (e.g., using a parallel computing platform) for processing data through one or more of applications and/or one or more tasks of a single application, substantially simultaneously. In at least one embodiment, the parallel computing platform (e.g., NVIDIA's CUDA®) may enable general purpose computing on GPUs (GPGPU) (e.g., GPUs). In at least one embodiment, a software layer of the parallel computing platform may provide access to virtual instruction sets and parallel computational elements of GPUs, for execution of compute kernels. In at least one embodiment, the parallel computing platform may include memory and, in some embodiments, a memory may be shared between and among multiple containers and/or between and among different processing tasks within a single container. In at least one embodiment, inter-process communication (IPC) calls may be generated for multiple containers and/or for multiple processes within a container to use same data from a shared segment of memory of the parallel computing platform (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, the AI services may be leveraged to perform inferencing services for executing machine learning model(s) associated with applications (e.g., tasked with performing one or more processing tasks of an application). In at least one embodiment, the AI services may leverage an AI system to execute machine learning model(s) (e.g., neural networks, such as CNNs) for segmentation, reconstruction, object detection, feature detection, classification, and/or other inferencing tasks. In at least one embodiment, applications of the deployment pipeline(s) may use one or more of output models from the training system and/or other models of applications to perform inference on imaging data (e.g., DICOM data, RIS data, CIS data, REST compliant data, RPC data, raw data, etc.). In at least one embodiment, two or more examples of inferencing using the application orchestration system (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, the application orchestration system may distribute resources (e.g., services and/or hardware) based on priority paths for different inferencing tasks of the AI services.

In at least one embodiment, shared storage may be mounted to AI services within the system for deploying a deployment pipeline. In at least one embodiment, shared storage may operate as a cache (or other storage device type) and may be used to process inference requests from applications. In at least one embodiment, when an inference request is submitted, a request may be received by a set of API instances of the deployment system, and one or more instances may be selected (e.g., for best fit, for load balancing, etc.) to process a request. In at least one embodiment, to process a request, a request may be entered into a database, a machine learning model may be located from the model registry if not already in a cache, a validation step may ensure an appropriate machine learning model is loaded into a cache (e.g., shared storage), and/or a copy of a model may be saved to a cache. In at least one embodiment, the scheduler (e.g., of the pipeline manager) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel-level segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between the services and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud, and an inference service may perform inferencing on a GPU.

In at least one embodiment, visualization services may be leveraged to generate visualizations for viewing outputs of applications and/or the deployment pipeline(s). In at least one embodiment, GPUs may be leveraged by the visualization services to generate visualizations. In at least one embodiment, rendering effects, such as ray-tracing or other light transport simulation techniques, may be implemented by the visualization services to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, the visualization services may include an internal visualizer, cinematics, and/or other rendering or image processing capabilities or functionality (e.g., ray tracing, rasterization, internal optics, etc.).

In at least one embodiment, the hardware may include GPUs, the AI system, the cloud, and/or any other hardware used for executing the training system and/or the deployment system. In at least one embodiment, the GPUs (e.g., NVIDIA's TESLA® and/or QUADRO® GPUs) may include any number of GPUs that may be used for executing processing tasks of the compute services, the collaborative content creation services, the AI services, the simulation services, the visualization services, other services, and/or any of features or functionality of software. For example, with respect to the AI services, the GPUs may be used to perform pre-processing on imaging data (or other data types used by machine learning models), post-processing on outputs of machine learning models, and/or to perform inferencing (e.g., to execute machine learning models). In at least one embodiment, the cloud, the AI system, and/or other components of the system may use GPUs. In at least one embodiment, cloud may include a GPU-optimized platform for deep learning tasks. In at least one embodiment, AI system may use GPUs, and cloud- or at least a portion tasked with deep learning or inferencing—may be executed using one or more AI systems. As such, although hardware is illustrated as discrete components, this is not intended to be limiting, and any components of hardware may be combined with, or leveraged by, any other components of hardware.

In at least one embodiment, AI system may include a purpose-built computing system (e.g., a super-computer or an HPC) configured for inferencing, deep learning, machine learning, and/or other artificial intelligence tasks. In at least one embodiment, AI system (e.g., NVIDIA's DGX™) may include GPU-optimized software (e.g., a software stack) that may be executed using a plurality of GPUs, in addition to CPUs, RAM, storage, and/or other components, features, or functionality. In at least one embodiment, one or more AI systems may be implemented in cloud (e.g., in a data center) for performing some or all of AI-based processing tasks of system.

In at least one embodiment, cloud may include a GPU-accelerated infrastructure (e.g., NVIDIA's NGC™) that may provide a GPU-optimized platform for executing processing tasks of system for deploying a deployment pipeline. In at least one embodiment, the cloud may include an AI system(s) for performing one or more of AI-based tasks of system for deploying a deployment pipeline (e.g., as a hardware abstraction and scaling platform). In at least one embodiment, the cloud may integrate with application orchestration system leveraging multiple GPUs to enable seamless scaling and load balancing between and among applications and the services. In at least one embodiment, the cloud may be tasked with executing at least some of the services of the system, the including compute services, the AI services, and/or the visualization services, as described herein. In at least one embodiment, the cloud may perform small and large batch inference (e.g., executing NVIDIA's TensorRT™), provide an accelerated parallel computing API and as suitable platform (e.g., NVIDIA's CUDA®), execute the application orchestration system (e.g., KUBERNETES), provide a graphics rendering API and platform (e.g., for ray-tracing, 2D graphics, 3D graphics, and/or other rendering techniques to produce higher quality cinematics), and/or may provide other functionality for system for deploying a deployment pipeline.

In at least one embodiment, in an effort to preserve patient confidentiality (e.g., where patient data or records are to be used off-premises), the cloud may include a registry, such as a deep learning container registry. In at least one embodiment, a registry may store containers for instantiations of applications that may perform pre-processing, post-processing, or other processing tasks on patient data. In at least one embodiment, the cloud may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, in some embodiments, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
processing, using a duplex neural network (NN), a first representation of a first speech utterance in a first language to obtain a second representation of a second speech utterance in a second language, the second speech utterance comprising a translation of the first speech utterance to the second language, wherein the duplex NN comprises a first subnetwork and a second subnetwork that includes a mirrored architecture of the first subnetwork.

2. The method of claim 1, wherein the duplex NN is deployed in a first direction, and the duplex NN is further trained to process data in a reverse direction.

3. The method of claim 1, wherein the first subnetwork comprises one or more neuron blocks comprising two or more of:
a fully-connected layer,
a convolutional layer,
a self-attention layer, or
a normalization layer.

4. The method of claim 1, wherein the first subnetwork comprises a neuron block performing operations comprising:
splitting a block input into a first portion and a second portion;
processing, using a first neuron module of the neuron block, the second portion; and
aggregating the first portion and the processed second portion to obtain a first block output.

5. The method of claim 4, wherein the operations performed by the neuron block further comprise:
processing, using a second neuron module of the neuron block, a copy of the first block output; and
aggregating a copy of the second portion and the processed copy of the first block output to obtain a second block output.

6. The method of claim 1, wherein the duplex NN comprises a conformer NN.

7. The method of claim 1, wherein the first representation comprises a set of embeddings obtained, at least in part, by processing, using an embeddings network, a first set of spectrograms for the first speech utterance in the first language.

8. The method of claim 1, wherein the duplex NN has been trained using one or more diffusion training techniques.

9. A method comprising:
obtaining training data that comprises a target output, a first training input, and a second training input, wherein the target output comprises a first representation of a first speech utterance in a first language, wherein the first training input comprises the target output distorted by a first noise, wherein the second training input comprises a second representation of a second speech utterance in a second language, and wherein the second speech utterance comprises a translation of the first speech utterance to the second language; and
training a neural network (NN) deployed in a first direction to identify, using the first training input and the second training input, at least one of:
the target output, or
the first noise.

10. The method of claim 9, wherein the NN comprises a duplex NN, wherein the duplex NN comprises a first subnetwork and a second subnetwork, an architecture of the first subnetwork being a mirror image of an architecture of the second subnetwork.

11. The method of claim 10, wherein the duplex NN comprises a conformer NN.

12. The method of claim 10, wherein the first noise is sampled from a random distribution.

13. The method of claim 10, further comprising:
obtaining additional training data that comprises an additional target output, a third training input, and a fourth training input, wherein the additional target output comprises a third representation of a third speech utterance in the second language, wherein the third training input comprises the additional target output distorted by a second noise, wherein the fourth training input comprises a fourth representation of a fourth speech utterance in the first language, and wherein the fourth speech utterance comprises a translation of the third speech utterance to the second language; and
training the NN deployed in a second direction to identify, using the third training input and the fourth training input, at least one of:
the additional target output, or
the second noise.

14. The method of claim 10, further comprising:
obtaining additional training data that comprises a third training input and an additional target output, wherein the third training input comprises a third representation of a third speech utterance in the first language, wherein the additional target output comprises a fourth representation of a fourth speech utterance in the second language, and wherein the fourth speech utterance comprises a translation of the third speech utterance to the second language; and
training the NN deployed in the first direction to generate, using the third training input, an output that emulates the additional target output.

15. The method of claim 10, wherein the first representation comprises a set of embeddings obtained by processing, using an embeddings network, a first set of spectrograms for the first speech utterance in the first language.

16. A system comprising:
one or more processing units to:
process, using a duplex neural network (NN) trained to perform translation in a first direction from a first language to a second language and in a second direction from the second language to the first language, a first representation of a first speech utterance in the first language to obtain a second representation of a second speech utterance in the second language, the second speech utterance including a translation of the first speech utterance to the second language.

17. The system of claim 16, wherein the duplex NN comprises a first subnetwork and a second subnetwork, an architecture of the first subnetwork being a mirror image of an architecture of the second subnetwork.

18. The system of claim 17, wherein the first subnetwork comprises a neuron block configured to:
split a block input into a first portion and a second portion;
process, using a first neuron module of the neuron block, the second portion;
aggregate the first portion and the processed second portion to obtain a first block output;
process, using a second neuron module of the neuron block, a copy of the first block output; and
aggregate a copy of the second portion and the processed copy of the first block output to obtain a second block output.

19. The system of claim 16, wherein to train the NN, the one or more processing units are to:
obtain training data that comprises a target output, a first training input, and a second training input, wherein the target output comprises a first representation of a first speech utterance in a first language, wherein the first training input comprises the target output distorted by a first noise, wherein the second training input comprises a second representation of a second speech utterance in a second language, and wherein the second speech utterance comprises a translation of the first speech utterance to the second language; and
train the NN deployed in a first direction to identify, using the first training input and the second training input, at least one of:
the target output, or
the first noise.

20. The system of claim 16, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system for generating or presenting at least one of augmented reality content, virtual reality content, or mixed reality content;
a system implemented using a robot;
a system for performing conversational AI operations;
a system implementing one or more large language models (LLMs);
a system for generating synthetic data;
a system incorporating one or more virtual machines (VMs);
a system implemented at least partially in a data center; or
a system implemented at least partially using cloud computing resources.
